(19) United States
(12) Patent Application Publication
(10) Pub. No.: US 2022/0127131 A1
(43) Pub. Date: Apr. 28, 2022

(54) Fuel Caddy with Hand Crank for Pump Located on the Nozzle

(71) Applicant: Shay Aaron Wells, Newcastle, OK (US)

(72) Inventor: Shay Aaron Wells, Newcastle, OK (US)

(73) Assignee: Seven Day Club, Newcastle, OK (US)

(21) Appl. No.: 17/081,069

(22) Filed: Oct. 27, 2020

(51) Int. Cl. B67D 7/60; B67D 7/04; B67D 7/84

(52) U.S. Cl. CPC B67D 7/60; B67D 7/845; B67D 7/04

(57) ABSTRACT

The invention broadly comprises a portable device (fuel caddy) for transferring fluids, particular for transferring gasoline from a storage container to gasoline using vehicles, boats or equipment. The device includes an external housing with an inlet and a discharge through a nozzle with a pump located on the external housing, with the pump operated by a hand crank located on the nozzle. The external housing includes all-terrain wheels, a tow loop for use on ATVs' and trucks, and an extended hose to the nozzle.

### FIELD OF INVENTION

The invention relates generally to portable device for transfer pumps. In particular, the invention relates to a portable transfer pump for transferring fuels, having an in-line motor and an ergonomic shape.

### BACKGROUND

Fueling equipment that is not convenient to a standard gas pumps station calls for either carrying gas tanks to the vehicle or machinery in need of fuel or bringing fuel to it in a fuel caddy, which is a large tank, on wheels with a delivery nozzle. The market has a need to have a method of fueling remote or stranded vehicles, such as cars, boats, ATVs or other recreational vehicles, industrial machinery, and farm equipment. The other major issue is that gas pumps at out of the way locations tend to charge very high prices, making a fuel caddy an attractive alternative even when gas pumps are available.

Three main products are on the market today that use rotary pumps of hand pumps at the dispensing point. Most products on the market pump air into the fuel storage container to push the gas out, which requires two person operation, and have problems with leakage and spillage.

SUNCOO's 30 Gallon Portable Gas Caddy Fuel Storage Tank on Wheels for gasoline or fluid diesel with a two way hand cranked rotary pump. This product does not have a nozzle, but has a hand crank that operates a two-way pump that pumps fuel out the fuel caddy into a tube, the fuel then goes out the tube into a funnel and then into the equipment needing fueling. This product can also pump out fuel remaining in vehicles or machinery when they won't be used for an extended period. The product's big drawback is needs two people to operate if the fuel caddy can't be brought right up to the vehicle, boat, farm equipment or industrial equipment. Scepter Marine DuraMax Flo offers a fuel caddy which offers a hand pump and a 10 feet hose. It does not have a nozzle and if the equipment being fueled right next to the caddy, the fuel caddy requires two people operation.

Northern's Flo Fast Gas Container with Pump and Cart, has a 15 gallon tank, with a rotary pump capable of eight gallons per minute, that pumps into a hose. This product does not have a nozzle and comes with a five foot hose.

Other products on the market are similar, they require two person operation unless the fuel caddy can be brought next to the equipment being fueled. And without a drip free nozzle, every fueling operation runs the risk of leaks or spills which is a major safety issue.

Other issues also exist with current fuel caddies. Current liquid fuel caddies use gravity, hand pump nozzles and drum pumps to dispense the liquid fuel from the container. When using gravity to feed the fuel from the container to the nozzle, the height of the fuel container needs to be higher than the height of the nozzle when dispensing the liquid fuel. Using a hand pump nozzle similar to what is shown in U.S. Pat. No. D516,673 to Chisholm & Alex (2006) will allow for the nozzle height to be higher than the fuel container and also allow the operator to be as far away from the fuel container as the hose length and pump capacity allow. Squeezing the hand pump nozzle can be strenuous, especially when dispensing large volumes of fuel. Drum pumps can dispense large volumes of fuel without strenuous activity or concern about the height of the dispensing nozzle to fuel container relationship, but the operator of current systems has to be at the fuel container actuating the drum pump. It is not safe for the operator to be at the fuel container when dispensing fuel because the container/tank being filled can overflow and spill on equipment or ground causing slip hazards or risk of fuel combustion, which means current drum pump products need two people to operate safely.

Another system on the market use an integral lever air pump that draws in air from atmosphere via a vacuum produced from a retracting piston. The air in the piston is then pressed into the fuel container when the piston is advanced by the hand lever. The compressed air is stored energy inside the fuel container provides pressure to push the liquid fuel through the hose when the nozzle valve is released. This method of fuel dispensing requires extra pressure on the tank which can be dangerous and also doesn't work well when the fuel caddy is running low on fuel, which leaves too much fuel in the caddy when it should be empty. This also creates flow problems, where the follow from the caddy varies depending on the inside air pressure.

The market has an unmet need for a fuel caddy with one person operation. It also requires a better dispensing system to minimize or eliminate spills and leaks while fueling. Fuel caddies also work best with drum rotary pumps as they supply more steady pressure, and can more effectively empty the tank. The other major issue with fuel caddies is that they need to offloaded from a truck or other vehicle, fueled a the gas station or other fueled source, then put back on the truck or vehicle and transported to a site near where the fuel caddy's fuel is needed. This series of events can cause issues if there is not a firm shut off point, such as a nozzle, and a locking position for the nozzle on the fuel caddy during transport.

### SUMMARY OF THE INVENTION

The basic function of this invention is to bring a hand cranked pump to the nozzle to allow one person dispensing. They key features is placing the hand crank right behind the nozzle, having the fuel caddy's gas tank on the top of one side so it can be loading lying flat, and using a three hook system to allow the caddy hose to be safely stored, rather than using a one hook system that allows the hose to move around excessively. The fuel caddy can have a main body that holds 15, 30, 35 or 60 gallons of fuel as well as other sizes. The main advantages of the invention are:
safety to those dispensing fuel because they are at the point of dispensing;
relief to strenuous activity of shifting back and forth from the fueling point to the fuel caddy;
ease of filling the liquid fuel container at the re-fueling station;
better and tighter storing for the fuel caddy hose;
foldable hand crank for storage.

### PART NUMBER DESCRIPTION

1. fuel dispense nozzle
2. gas flow control mechanism
3. gas flow control lever
4 gas hose
5. rotary pump
6. handle to operate crank
7. crank to operate pump
8. swivel connection for gas hose.
9. gas hose connection
10. metal gas hose connection port on the fuel caddy
11. gas hose connection that connects to 10
12. swivel on the gas hose that connects to fuel caddy.
13. side grips, which are part of the mold of the gas caddy.
14. off road tires.
15. gas cap for filing fuel caddy.
16. top hook positions, for two hooks, for gas hose to hang up.
17. lower hook position, creating a triangle effect for the hooks, the hose to hang up.
18. back hook, allows the fuel caddy to attach to a ladder and also helps to keeps the fuel caddy level when lying horizontally.
19. adding a hand grip to the bottom of the mold for lifting.
20. towing attachment.
21. integrated gas flow control mechanism and rotary pump with handle.
22. connector on rotary pump to connect with the gas flow control mechanism.
23. connector on the gas flow control mechanism to connect with the rotary pump.
24. hinges for the towing attachment.
25. support bars for the towing attachment, connecting the towing attachment to the hinges.
26. quick snap holder for the towing attachment.

### BRIEF DESCRIPTION OF FIGURES

FIG. 1 shows the nozzle, location of the hand crank and rotary drum. The hand crank folds over the rotary drum when not in use.

FIG. 2 shows the front of the fuel caddy with the fuel caddy not in use.

FIG. 3 shows a side view of the fuel caddy with the hose coming out of the connector on the lower front.

FIG. 4 shows the side view of the fuel caddy.

FIG. 5 shows the back side of the fuel caddy.

FIG. 6 shows details of the towing attachment.

FIG. 6 shows the front side of the fuel caddy and is a view when the fuel caddy is in use, versus FIG. 2 which shows the front of the fuel caddy when it is not in use.

FIG. 7 shows the integrated rotary pump and the gas flow control mechanical device.

FIG. 8 shows the front side of the fuel caddy and is a view when the fuel caddy is in use, versus FIG. 2 which shows the front of the fuel caddy when it is not in use.

### DETAILED DESCRIPTION

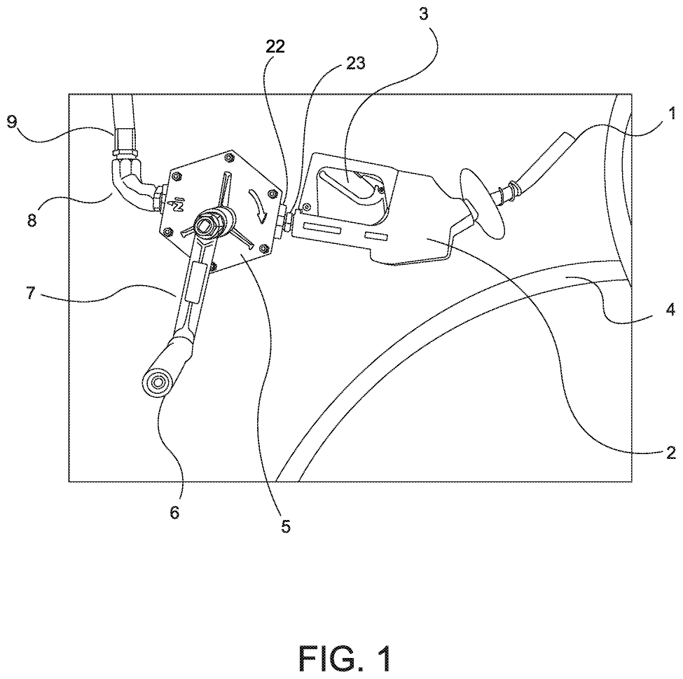

FIG. 1 illustrates the fueling components of the fuel caddy as it ready to fuel. The fuel dispensing nozzle 1 goes into the vehicle, ATV, boat or machinery, being fueled, the nozzle is an integral pan of the gas flow control device 2, which has a cutout section where the gas flow control lever 3 fits. The gas flow control mechanical device 2 connects to the rotary pump 5, which is operated by the hand crank 6 which also has a foldable part 7 that allows the handle to fold over the rotary pump 5 when not in use. The gas line 4, is quite long as it leaves the rotary pump 5 going back to the fuel caddy. The gas line 4 is a flexible tube that can works it way through or over obstructions. The gas line has a swivel connector 8 to allow the gas line to rotate, and it is connected to the gas line through connector 9 which sits on the gas line 4.

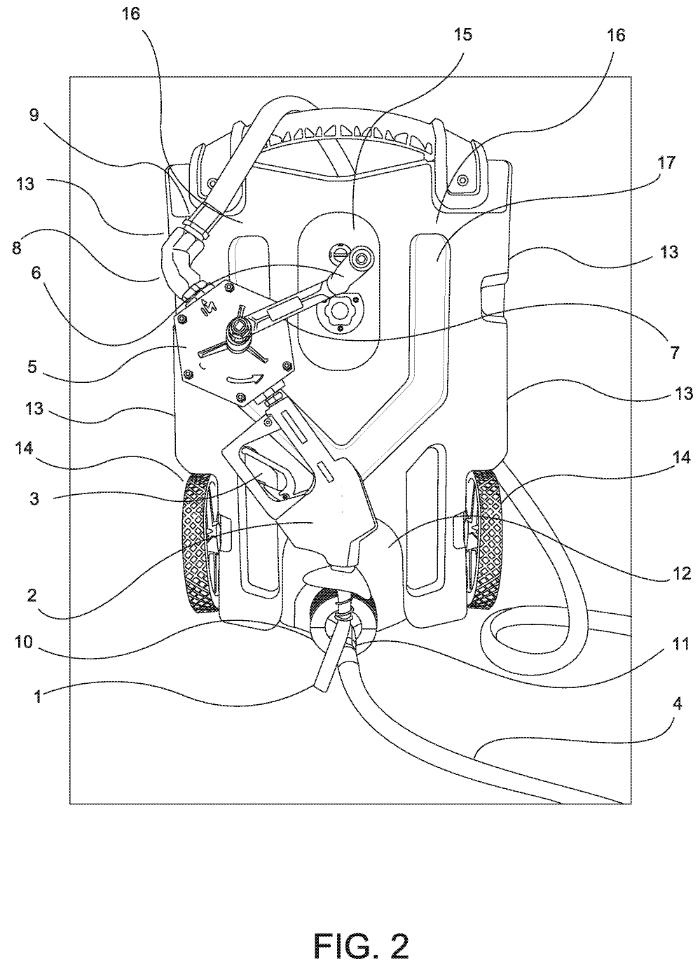

FIG. 2 illustrates the front of the fuel caddy when it is not in use. The second end of the gas hose 4 has a connector 11 which is attached to a swivel 12 and connected to the metal connection port on fuel caddy 10. The molded body of the fuel caddy has two handles 13 molded in, one higher than the other on each side of the fuel caddy, two hooks near the top of the fuel caddy 16 and a hook further down on the left side 17, are there to wind up the gas hose 4 when the fuel caddy is not use. The figure also shows how the swivel connection 8, which is attached to the rotary pump 5 connects to the gas line connector 9. The gas flow control mechanical device 2 with the gas nozzle 1, gas flow control lever 3 are shown draped into position, based on the extra hose that isn't wrapped around hooks 16 or 17. Another notable feature in FIG. 2 is the off-road tires 14.

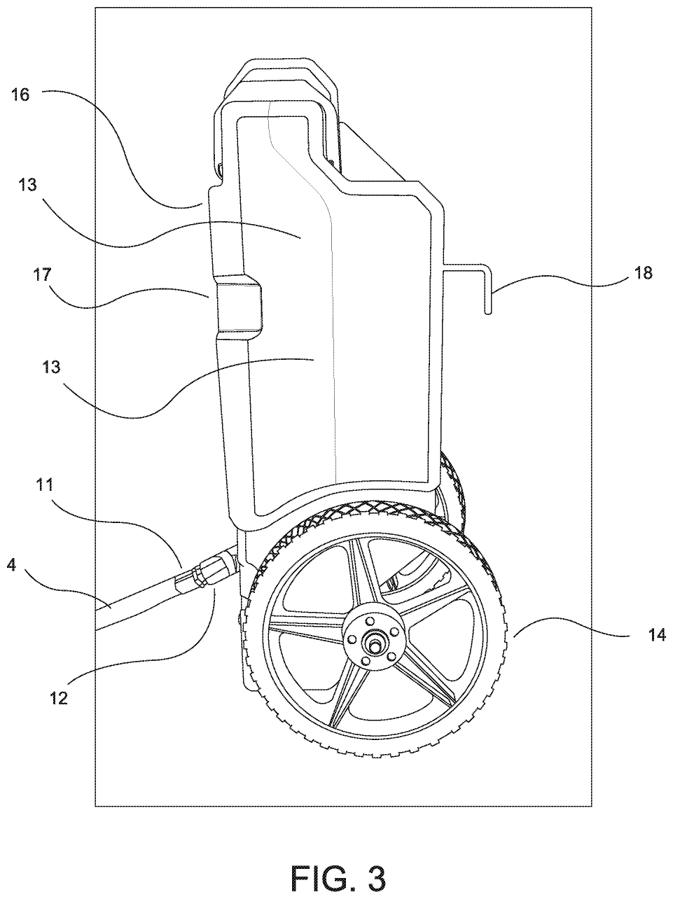

FIG. 3 illustrates the side view of the fuel caddy, showing the bottom connection the gas line 4, showing the second swivel connected to the fuel caddy and the gas line connection 11. Also shown are the location of the two molded in handles 13, the off-road wheels 14, the one hook location 16 for winding the gas line 4, and the back hook 18.

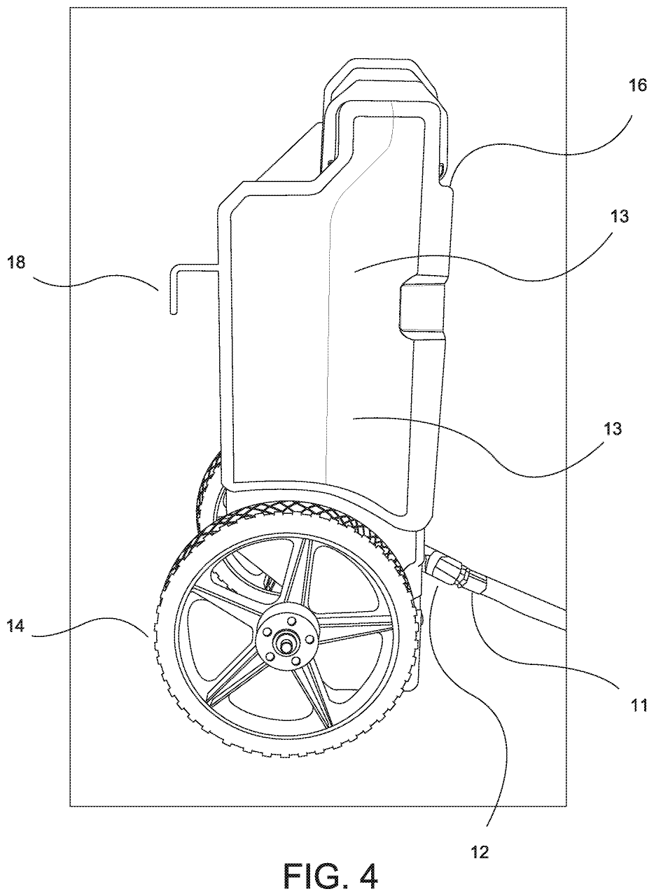

FIG. 4 illustrates the opposite side view of the fuel caddy showing the bottom connection the gas line 4, showing the second swivel connected to the fuel caddy and the gas line connection 11. Also shown are the location of the two molded in handles 13, the off-road wheels 14, the one hook location 16 for winding the gas line 4, and the back hook 18.

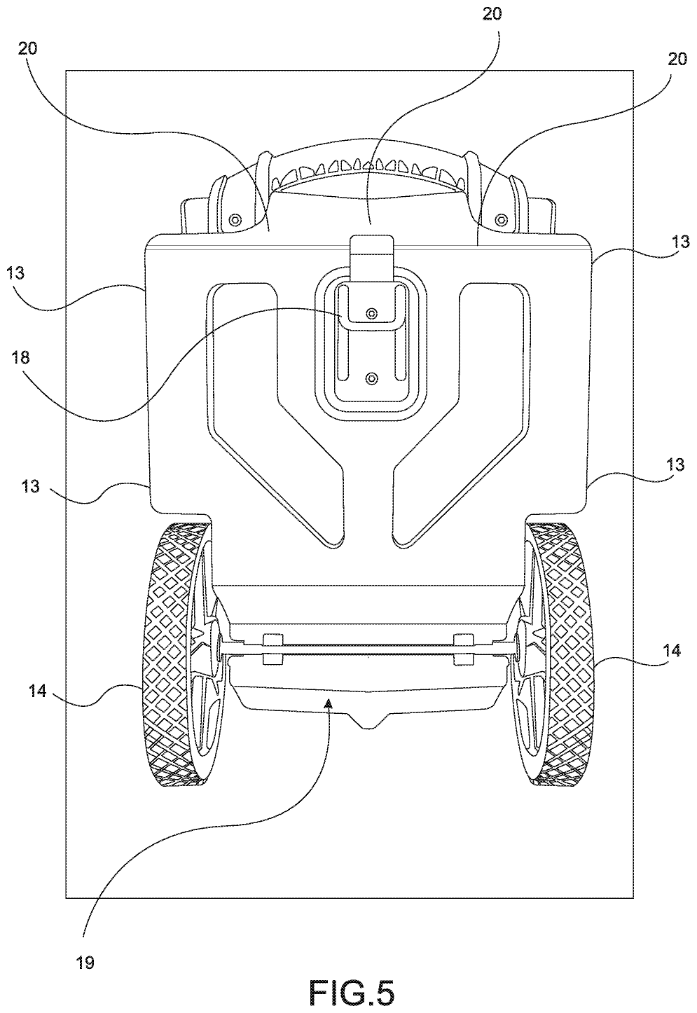

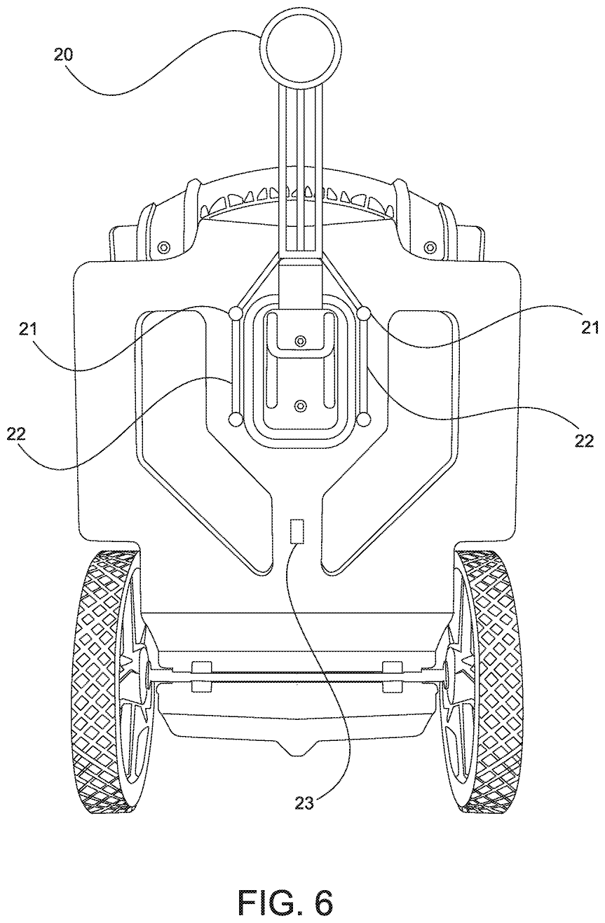

FIG. 5 illustrates the back side of the fuel caddy, showing the off-road wheels 14, the handle molded 19 into the fuel caddy to facilitate lifting, the towing attachment 20, and the back hook 18, which mounts over a ladder leg. Also shown are the four handles 13, two on either side which facilitate lifting of the fuel caddy.

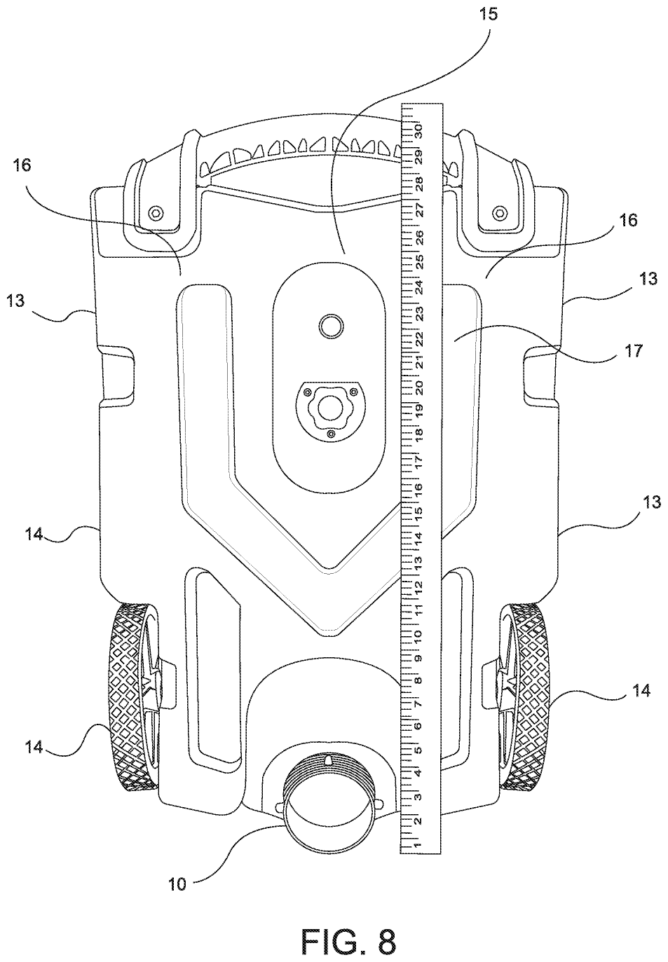

FIG. 8 illustrates the towing attachment 20 with its key components, the hinges 24, the support bars 25 and the quick snap holder for the towing attachment 26. When in use the towing attachment 20 is positioned as shown in the drawing, when not in use the twoing attachment is swung down and locked in place with the quick snap holder. The fuel caddy is towed in the horizontal position.

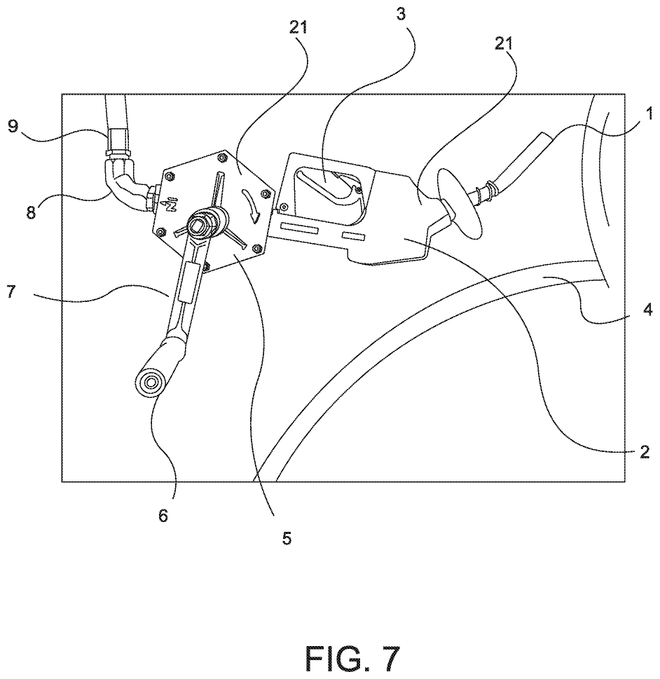

FIG. 7 illustrates the key feature of the preferred embodiment, with the rotary pump 5 with hand crank 7 an integral part with the gas flow control mechanism, both combined in one part 21.

FIG. 8 illustrates the front of the fuel caddy when the caddy is in use, with the gas line and gas flow control mechanism device at the fueling point. The second end of the gas hose 4 has a connector 11 which is attached to a swivel 12 and connected to the metal connection port on fuel caddy 10. The molded body of the fuel caddy has two handles 13 molded in, one higher than the other on each side of the fuel caddy, two hooks near the top of the fuel caddy 16 and a hook further down on the left side 17, are there to wind up the gas hose 4 when the fuel caddy is not use.

I claim:

1. A liquid fuel caddy that facilitates one-hand operation comprising:
a solid body molded fuel caddy body;
gas line exiting the bottom of the fuel caddy;
the gas line connecting to an integrated part for dispensing containing a gas flow control mechanism and a rotary pump;
the integrated part with a fueling nozzle;
the integrated part with a gas flow control lever;
the integrated part with a hand crank for the rotary pump;
the gas line exiting the rotary pump section of the integrated part that connects to the gas line through a first connection;
the gas line from the rotary pump connecting section of the integrated part to the second connection on the bottom of the molded fuel caddy;
the solid molded fuel caddy body containing hooks to facilitate wrapping the gas line when the fuel caddy is not in use.

2. The device of claim 1 where the integrated gas flow control mechanical device and rotary drum pump separated into two components connected by a male connecting fitting on the gas flow control mechanic device and a female connecting device on the rotary pump.

3. The hand crank of the device of claim 1 that folds over the rotary pump for storage.

4. The solid body molded fuel caddy body having a hook on one side to position over a ladder rung.
